(19) United States
(12) Patent Application Publication
(10) Pub. No.: US 2007/0275739 A1
(43) Pub. Date: Nov. 29, 2007

(54) Method and System for Authorising Short Message Service Messages

(75) Inventor: Romilly Blackburn, Victoria (AU)

Correspondence Address: OLIFF & BERRIDGE, PLC, P.O. BOX 19928, ALEXANDRIA, VA, 22320, US

(73) Assignee: Three B Technologies PYT LTD, Victoria (AU)

(21) Appl. No.: 10/575,547

(22) PCT Filed: Oct. 6, 2004
(86) PCT No.: PCT/AU04/01356

§ 371 Date: May 14, 2007

(30) Foreign Application Priority Data
Oct. 8, 2003 (AU) 2003905482

(51) Int. Cl. H04Q 7/20

(52) U.S. Cl. 455/466; 709/206

(57) ABSTRACT

Short message service (SMS) messages are sent by a sender (501) to a recipient (502) over a communications network (503). An SMS message is received (401) from the sender. An automatic verification request is sent (402) to the sender requesting a verification response, with the verification request being sent before the SMS message is delivered to the recipient. The verification response is received (403) from the sender; and the SMS message is delivered (404) to the recipient upon receiving the verification response. A system for delivering the SMS messages includes receiving means (504) for receiving the SMS message from the sender, transmission means (505) for sending an automatic verification request to the sender requesting a verification response, receiving means (506) for receiving the verification response from the sender, and delivering means (507) for delivering SMS message to the recipient upon receiving the verification response.

### FIELD OF THE INVENTION

The present invention relates generally to short message service (SMS) messages, and more specifically, to a method and system for authorising SMS messages transmitted on a mobile telephone network.

### BACKGROUND OF THE INVENTION

Unsolicited electronic mail (email), often referred to as bulk electronic mail, “spam,” or “junk email,” has long plagued computer and Internet users. Unsolicited email is often of a commercial nature sent indiscriminately to individuals, mailing lists, or newsgroups. With the widespread and growing use of short message service (SMS) messages over mobile networks, mobile telephone users are now subject to unsolicited SMS messages.

The present invention provides a method and system for authorising SMS messages on a mobile telephone that overcomes or alleviates one or more problems related to unsolicited or unwanted SMS messages.

### SUMMARY OF THE INVENTION

According to one embodiment of the present invention, a method for delivering short message service (SMS) messages sent by a sender to a recipient over a communications network is disclosed. The method includes receiving an SMS message from the sender; sending an automatic verification request to the sender requesting a verification response, wherein the verification request is sent before the SMS message is delivered to the recipient; receiving the verification response from the sender; and delivering the SMS message to the recipient upon receiving the verification response.

According to another embodiment of the present invention, a system for delivering short message service (SMS) messages sent by a sender to a recipient over a communications network is disclosed. The system includes receiving means for receiving an SMS message from the sender; transmission means for sending an automatic verification request to the sender requesting a verification response, wherein the verification request is sent before the SMS message is delivered to the recipient; receiving means for receiving the verification response from the sender; and delivering means for displaying the SMS message to the recipient upon receiving the verification response.

According to yet another embodiment, the method and system further includes verifying the SMS message, wherein the SMS message includes a sender identification and verifying the SMS message includes comparing the one or more sender lists, the one or more sender lists including a white list, and the SMS message is delivered to the recipient where the sender identification is included in the white list, and a verification request is sent to the sender where the sender identification is not included in the white list.

The SMS message may be received by a mobile telephone, wherein delivering the SMS message to the recipient includes allowing display of the SMS message on the mobile telephone. The SMS message may also be received by a system server, wherein delivering the SMS message to the recipient includes transmitting the SMS message from the system server to the mobile telephone.

According to another embodiment, the one or more sender lists are stored on a mobile telephone SIM card, mobile telephone memory or a system server database.

### BRIEF DESCRIPTION OF THE DRAWINGS

These and other features, aspects, and advantages of the present invention will become better understood with regard to the following description and accompanying drawings where:

FIG. 1 is a block diagram of a communications network in accordance with an embodiment of the present invention.

FIG. 2 is a flowchart diagram of an application operation process in accordance with an embodiment of the present invention.

FIG. 3 is a flowchart diagram of an application user interface in accordance with an embodiment of the present invention.

FIG. 4 is a flowchart diagram of a method according to a simplified embodiment of the invention.

FIG. 5 is a block diagram of a system according to a simplified embodiment of the invention.

### DETAILED DESCRIPTION

The detailed description set forth below in connection with the appended drawings is intended as a description of example embodiments of the present invention and is not intended to represent the only embodiments in which the present invention can be practiced. The embodiments described throughout this description are intended to serve as an example or illustration of the present invention and should not necessarily be construed as preferred or advantageous over other embodiments. Any number of the described embodiments may be incorporated in any desired combination. The detailed description includes specific details for the purpose of providing a thorough understanding of the present invention. However, it will be apparent to those skilled in the art that the present invention may be practiced without these specific details.

In the following description, reference is made to the accompanying drawings, which form a part hereof, and through which is shown by way of illustration specific embodiments in which the invention may be practiced. It is to be understood that other embodiments may be used as structural and other changes may be made without departing from the scope of the present invention.

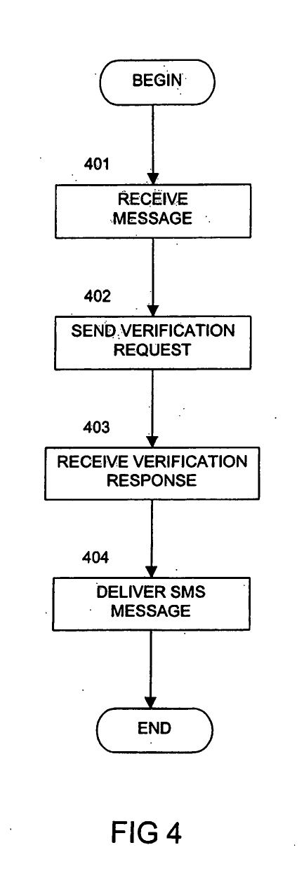

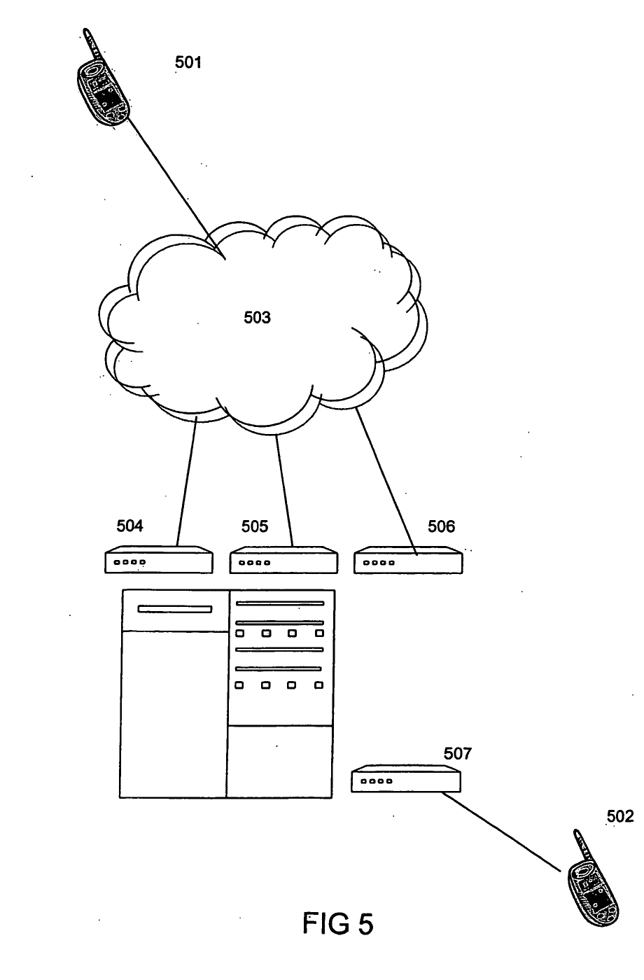

Referring firstly to FIG. 4 and FIG. 5, simple embodiments of the invention are illustrated. Short message service (SMS) messages are sent by a sender 501 to a recipient 502 over a communications network 503. An SMS message is received 401 from the sender. An automatic verification request is sent 402 to the sender requesting a verification response, with the verification request being sent before the SMS message is delivered to the recipient. The verification response is received 403 from the sender; and the SMS message is delivered 404 to the recipient upon receiving the verification response. A system for delivering the SMS messages includes receiving means 504 for receiving the SMS message from the sender 501, transmission means 505 for sending an automatic verification request to the sender 501 requesting a verification response, receiving means 506 for receiving the verification response from the sender, and delivering means 507 for delivering the SMS message to the recipient 502 upon receiving the verification response.

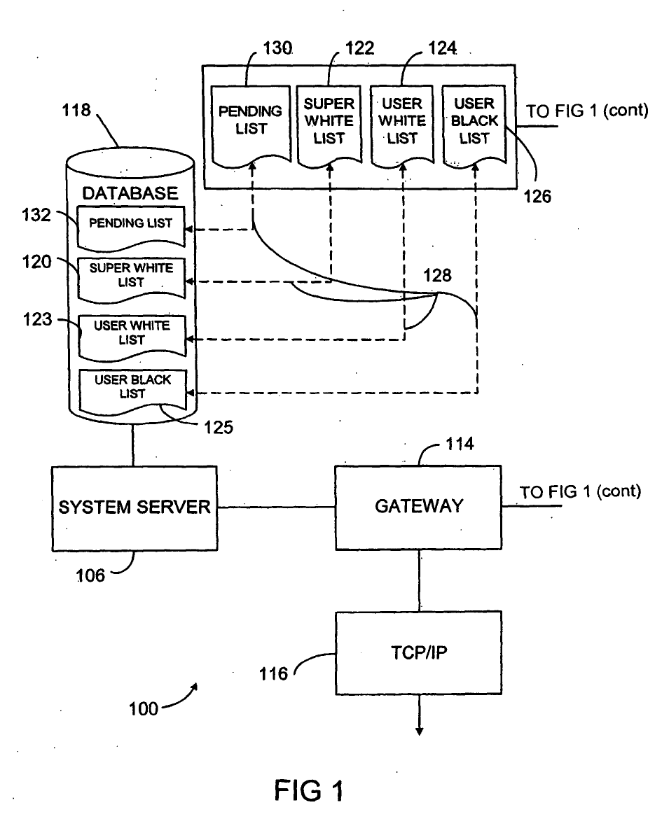

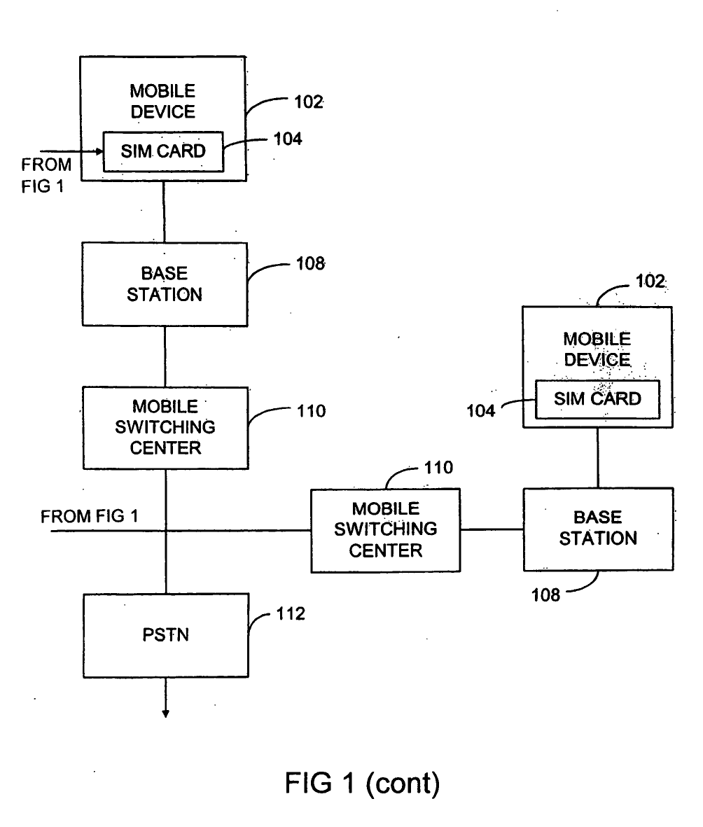

Referring now to FIG. 1, a block diagram of a communications network 100 in accordance with an embodiment of the present invention is shown. According to one example embodiment, the communications network is a mobile telephone network using any suitable cellular, digital cellular, digital, or other communications system such as, for example, a Global System for Mobile (GSM), a Time Division Multiple Access (TDMA) system, a Code-Division Multiple Access (CDMA) system, an Advance Mobile Phone Service (AMPS), or any other suitable communications system. A plurality of mobile devices 102 is provided on the communications network 100. According to one example embodiment, the mobile device is a mobile telephone, such as a cellular phone, personal communications service (PCS) phone, general packet radio service (GPRS) phone, or any other suitable mobile phone. However, the mobile device may be any other mobile or wireless device including, but not limited to, personal data assistants (PDAs), two-way pagers, laptop computers, global positioning system (GPS) devices, short message service (SMS) devices, and any other mobile device that is capable of receiving SMS messages. In one embodiment, the mobile devices include a Subscriber Identity Module (SIM) and is SIM toolkit enabled. However, other platforms may be used such as, for example, Java 2 Platform Micro Edition (J2ME), and any other mobile device platforms. According to one example embodiment, the plurality of mobile devices communicate on the communications network 100 using radio waves using radio frequency (RF) field propagation.

The telecommunications network 100 illustrated in FIG. 1 includes a plurality of devices that may commonly be found in a mobile telephone network. While two mobile devices 102 are illustrated, the network 100 may include any number of mobile devices communicating within and across a plurality of cells or networks. A cell is a generally geographical area covered by a cellular transmitter facility, such as a base station or cellular tower. A software application is stored in memory of the mobile device. In one embodiment, the application is a SIM-based Java application or embedded C application stored in a SIM card 104 of the mobile device 102. The application may be downloaded over the network 100 from a system server 106 or preinstalled on the SIM card 104. The application may be any suitable application configured to operate on the mobile device 102. An example application type is a Java-based application configured for operation on an embedded device or other microprocessor-based consumer products.

Each of the mobile devices 102 is operationally coupled to the communications network via a base station 108. In one embodiment, the mobile device 102 is in communication with the base station 108 using RF waves or any other suitable wireless communication protocol. The base station 108, or cell tower or any other system for receiving mobile device transmissions, is the relay station that a mobile device communicates with when initiating or receiving a wireless transmission. Generally, the base station 108 transmits voice and data to other devices over a forward control channel (FOCC) and mobile devices transmit voice and data to the base station over a reverse control channel (RECC). The base station 108 manages voice and data traffic between mobile devices and an associated mobile switching centre (MSC) 110.

Each of the base stations 108 is operationally coupled to the associated mobile switching centre 110, which is a computer-controlled switch for managing automated network operations. Each of the mobile switching centres 110 automatically coordinates and switches transmissions between mobile phones in a given service area. Generally, each cell in a mobile network is controlled by a single MSC. According to one embodiment, each of the MSCs 110 is coupled to the associated base station 108 by T1 lines, or equivalent communication lines, or microwave channels. However, any suitable communication line may be used. According to another embodiment, each of the MSCs 110 is coupled to the public service telephone network 112 by T1 lines, or equivalent communication lines, or landlines.

Each of the MSCs 110 is operationally coupled to one or more gateways 114. According to one embodiment, each of the MSCs 110 is coupled to the one or more gateways 114 by T1 lines, or equivalent communication lines, or microwave channels. The gateway 114 is a network point that acts as an entrance to another network. According to one example embodiment, the gateway 114 provides access to TCP/IP based networks 116 and also facilitates communication with the system server 106. The gateway 114 may include gateway software for use on Solaris and Linux platforms. However, other platforms may be used. In the embodiment illustrated in FIG. 1, the system server 106 transmits data to and receives data from the mobile device user using the gateway 114 using an SMP protocol. However, other communication lines and protocols may be used. For example, the system server 106 may communicate with the user using the mobile switching centre 110, using a PSTN 112, or using a TCP/IP connection.

The system server 106 may be operationally coupled to one or more databases 118 or other memory storage devices for storing user data, a plurality of super white lists 120, user white lists 123, user black lists 125, pending lists 132, and other sender lists, and any other desired information.

A plurality of user lists is stored on the SIM card 104 or other memory storage means on the mobile device 102. In the illustrated embodiment, a super white list 122, a user's white list 124, a user's black list 126, and a pending list 130 are stored on the SIM card 104. Communications lines 128 illustrates the synchronization between the sender lists stored on the data base 118 and the sender lists stored on the SIM card 104 of the mobile device 102. For example, there may be synchronization between the pending list 130, super white list 122, user white list 124, and user black list 126 stored on the SIM card 104 and the pending list 132, super white list 120, user white list 123, and user black list 125 stored on the database 118. In one embodiment, updates to the sender lists made by the system server 106 will be automatically synchronised with the sender lists stored on the SIM card 104. Synchronization may occur whenever changes are made, upon request, or after predetermined time intervals. While only the sender lists are shown having synchronization capabilities, other user lists, and other data, may be synchronised and shared between the mobile device 102 and the system server 106.

The illustrated communications network 100 is only one simplified example of a network used for voice, electronic, and Internet communications. Any suitable network configuration may be used. The network configuration may vary depending on the particular type of network being used.

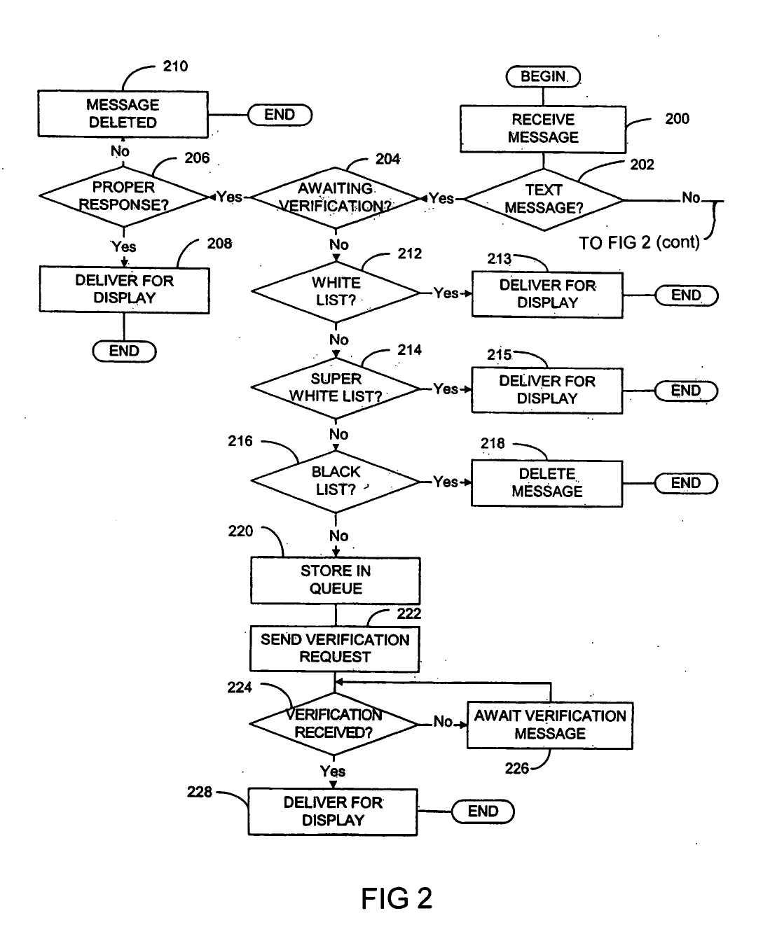

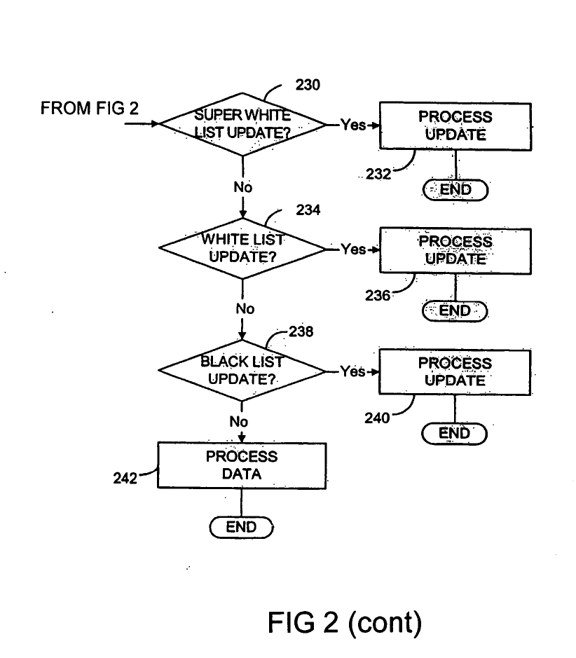

FIG. 2 is a flowchart diagram of an SMS authorising system process in accordance with an embodiment of the present invention. An SMS message sender creates and sends a SMS message to a specified mobile telephone number, the SMS recipient. The corresponding mobile telephone receives the SMS message, step 200. The application receives the SMS message and determines the type of the message received. The message may be one of: (a) an SMS text message; (b) a binary SMS “super white list” update; (c) a binary SMS “white list” update; and (d) a binary SMS “black list” update. In step 202, the application determines if the message is an SMS text message. If the SMS message is a SMS text message, the application checks if the message is from a telephone number that is in a list of telephone numbers for which there are SMS messages awaiting verification, step 204. From this comparison, the application determines whether the message is a proper response to the verification request, step 206. In step 208, if the message is a proper response, the application delivers the messages that are associated with the verification response for display. The determination of whether the SMS message is a successful verification reply is based upon the type of verification method employed by the mobile telephone user. In one embodiment, either a reply-based verification or name-based verification may be used. However, other verification methods may be used. For reply-based verification, the receipt of a reply message is sufficient in itself whereas for name-based verification, the SMS message needs to be matched in a fuzzy manner for the name of the mobile telephone user. If the verification message is not a successful verification reply, the message is discarded, step 210.

If the SMS message sender's telephone number is not in the verification list, a lookup of the SMS message sender's telephone number is performed against the SIM based sender lists, including a white list, a super white list, and a black list. A user's white list includes a list of telephone numbers, the contents of the list controlled by the mobile device user, from which SMS messages are displayed on the mobile device. In one embodiment, the white list may be the address book that is stored on the SIM card or other memory means in the mobile device. A super white list includes a list of telephone numbers, the list controlled by a mobile network administrator, from which SMS messages are displayed on the mobile device. A black list is a list of telephone numbers from which SMS messages are not displayed on the mobile device. The black list may be created and controlled by the mobile device user, the mobile network administrator, or any combination of shared control. These sender lists may be stored on the SIM card or other memory means in the mobile device.

In step 212, the application determines whether the SMS message sender's telephone number is listed in the white list. If the SMS message sender's telephone number is listed in the white list, then the SMS message is delivered for display, step 213. For example, the SMS message may be delivered to the mobile device “inbox” and an alert sounded to inform the mobile device user that a new SMS message has arrived. In step 214, the application determines whether the SMS message sender's telephone number is listed in the super white list. If the SMS message sender's telephone number is listed in the super white list, then the SMS message is delivered for display, step 215.

If the SMS message sender's telephone number is not in the list of those numbers awaiting verification, not listed in the white list, and not listed in the super white list, the application determines if the SMS message senders telephone number is listed in the black list, step 216. If the SMS message sender's telephone number is listed in the black list, the SMS message is not delivered for display, step 218. A reply message may be sent to inform the sender that the message has been returned and not viewed by the user. In one embodiment, the SMS message may be deleted. In another embodiment, the SMS message may be stored in a black list folder of “black listed” SMS messages where they are kept for a predetermined period of time before they are permanently deleted. In yet another embodiment, messages in the black list folder may be viewed by the user upon user selection.

If the SMS message sender's telephone number is not in the list of those numbers awaiting verification and not in any of the sender lists, the telephone number and associated SMS message are stored in a list or queue of messages awaiting sender verification, step 220. The telephone numbers and associated messages may be stored on the SIM card or other memory means on the mobile device. In step 222, a verification request is then sent to the SMS message sender, the content of which may depend on the type of verification method being used. In one embodiment, the mobile device user may view the list of telephone numbers that are awaiting verification messages. Also, the user may be able to view the SMS messages awaiting verification if desired. In one embodiment, a preview format may only allow the user to see a limited number of characters or words of the SMS message. In another embodiment, the user may see the entire SMS message upon request.

In step 224, the application checks for the receipt of a verification message. If the verification reply has not been received, the mobile device awaits a verification message, step 226. The mobile device may function normally while awaiting verification messages. In one embodiment, the mobile device may save the SMS message and await the verification message for a predetermined period of time. After the predetermined period of time has elapsed, the mobile device may delete the pending SMS message and cease awaiting the verification message.

In step 228, if a proper verification reply is received including a proper response, the SMS message is released from the queue and delivered for display.

If the received message is not a text message, the application determines whether the message is a binary SMS super white list update, step 230. If the message is a binary SMS super white list update, the application processes the update, step 232. If the message is not a binary SMS super white list update, the application determines whether the message is a binary SMS white list update, step 234. If the message is a binary SMS white list update, the application processes the update, step 236. If the message is not a binary SMS white list update, the application determines whether the message is a binary SMS black list update, step 238. If the message is a binary SMS black list update, the application processes the update, step 240. If the message is not a binary SMS black list update, the application processes the data as non-text message and non-update type data, step 242. If the message cannot be processed by the application, the message may be discarded and a reply may be generated and sent to the sender informing them that the message could not be processed.

The flowchart diagram illustrated in FIG. 2 is only one example of the SMS authorising system's operation. Any number of changes and variations may be made. For example, the system may make decisions in any desired order. For example, instead of checking first for the receipt of a text message, step 202, the system may check to determine whether the received message is an update message. Also, the illustrated steps may be included in any combination. For example, the system may only include steps relating to the white list and not include steps related to the black list or super white list. Also, additional steps may be added to the process as desired.

In one embodiment, the user may control the display of messages from telephone numbers listed in the super white. For example, the user may choose to only receive SMS messages that have been explicitly identified in the white list.

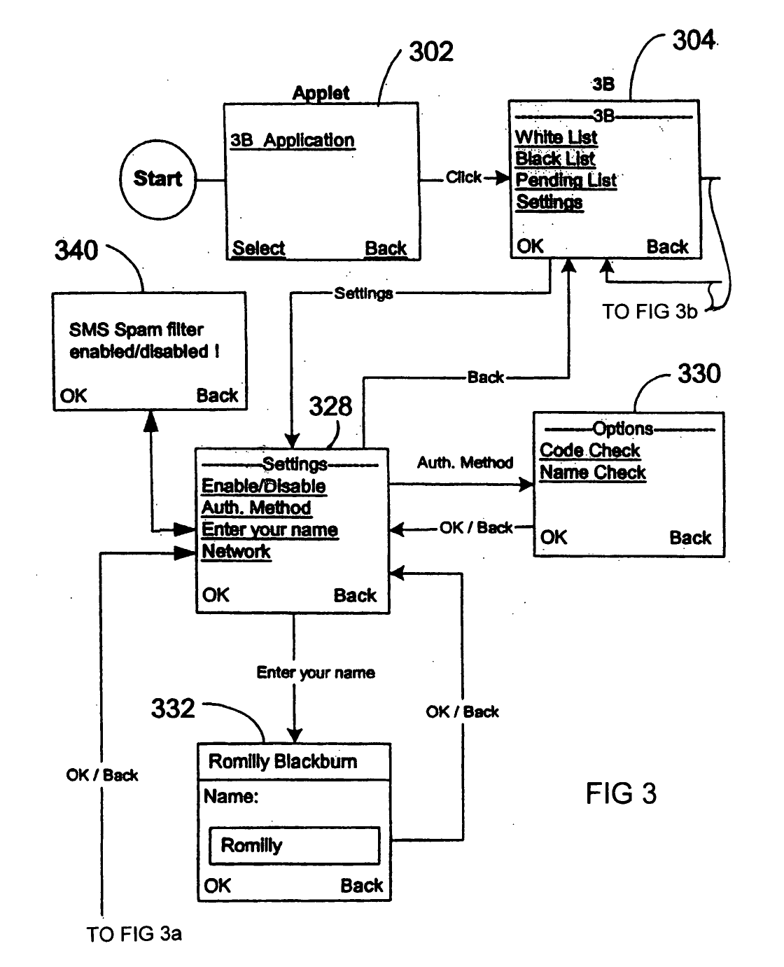

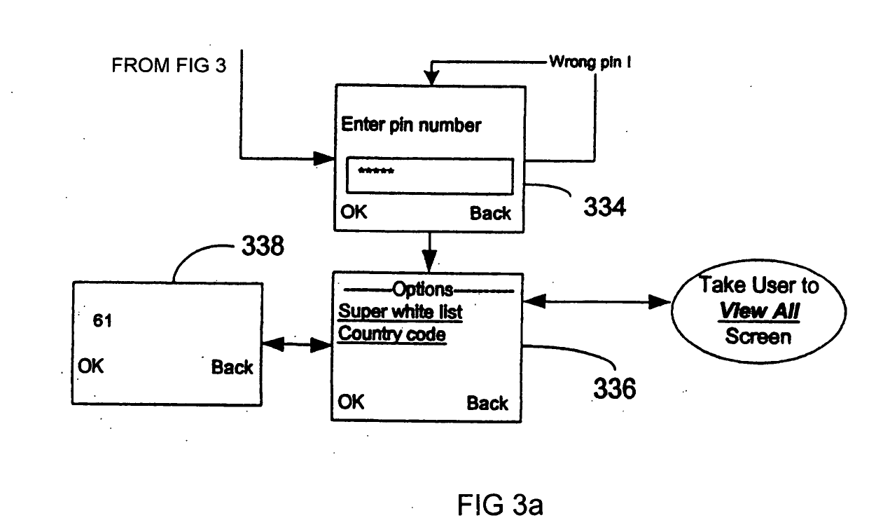

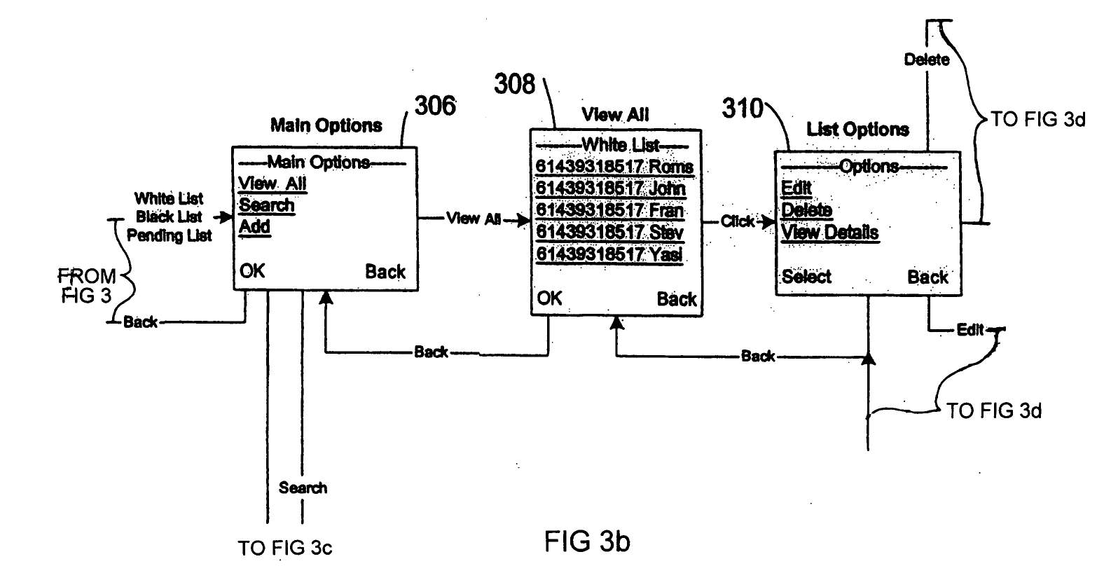

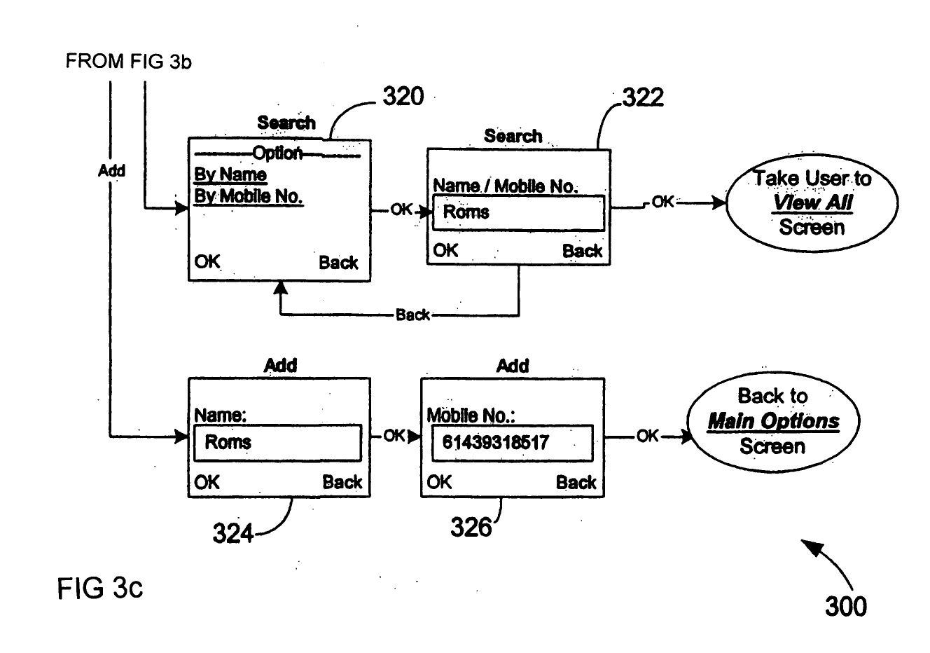

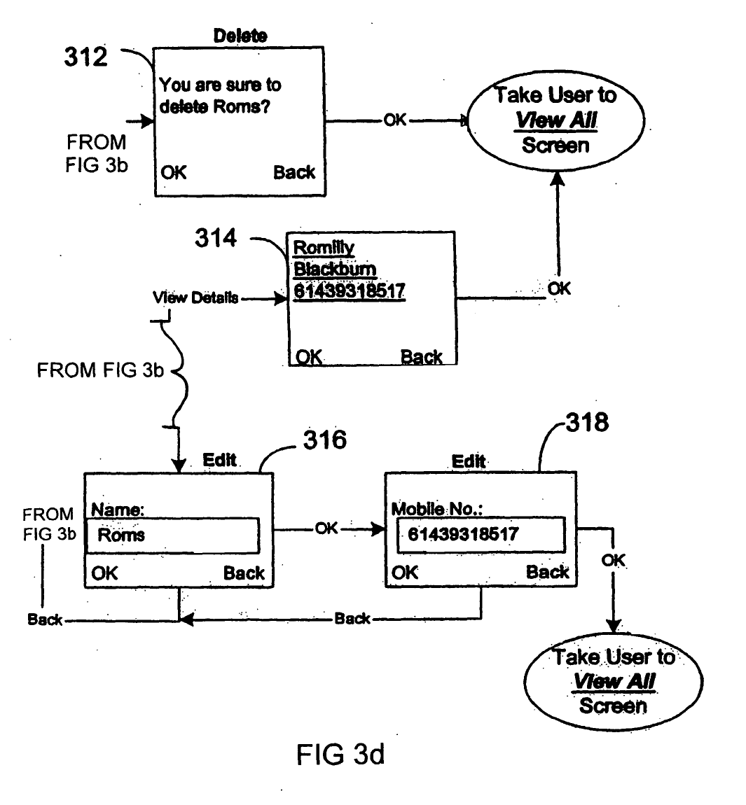

Referring now to FIG. 3, a flowchart diagram of an application user interface, in accordance with an embodiment of the present invention, is shown. The illustrated user interface diagram 300 starts at an application menu 302 including a list of available applications. The menu 302 includes an example SMS authorisation application titled “3B application.” Each of the illustrated menus includes items in a list form. Each of the items may be highlighted, pointed to, or otherwise selected. Selection of the item will display a different menu or display screen. Each of the menus or display screens may include a “back” option that allows the user to return to the immediately previous display screen. Each of the menus or display screens may include an “ok” or “select” that allows the user to view the next display screen or select the highlighted item. Each of the ok, select, and back options may have an associated button on the mobile device for activation.

Selection of the 3B application displays a 3B application menu 304 including white list, black list, pending list, and setting options. A selection of one of the user lists displays a main options menu 306 including view all, search, and add options. Operation of the menus is similar for each of the white list, black list, and pending list. Therefore, only operation of the white list is shown in the illustrated diagram. Operation of the application for each of the lists may be modified slightly to meet the requirements of the various types of list. For example, editing options may not be necessary for the pending list since the information was received from an incoming message. Selection of the view all option displays a view all menu 308 including a list of names and associated telephone numbers. In one embodiment, the white list and super white list may be displayed as one list on the user's mobile device. In another embodiment, each of the lists may have separate display options. A selection of one of the names/telephone numbers displays an options menu 310 including edit, delete, and view details options. Selection of the delete option displays a delete confirmation menu 312. Selection of ok deletes the selected name/telephone number from the list and returns the user to the view all menu 308. Selection of the view details option may display a more complete detail screen 314 of the selected name/telephone number. Selection of ok returns the user to the view all menu 308. Selection of the edit option displays an edit name screen 316. After making any desired changes to the name, selection of ok confirms the changes made and displays an edit telephone number screen 318. After making any desired changes to the telephone number, selection of ok confirms the changes made and returns the user to the view all menu 308. At the main options menu 306, selection of the search option displays a search menu 320. Selection of either the “by name” or “by mobile no.” option displays a search input screen 322. The search input screen 322 will receive user input and search for either a name or a telephone number depending on which option was selected. Selection of ok confirms the display of the search results (not shown) and returns the user to the view all menu 308. At the main options menu 306, selection of the add option displays an add name input screen 324. The user may input a name and select ok, which displays an add number input screen 326. The user may then input a telephone number and select ok, which adds the name and associated telephone number to the selected list and returns the user to the main options menu 306.

At the 3B application menu 304, selection of the settings option displays a settings menu 328 including authorization method, enable/disable, network, and “enter your name” options. Selection of the authorization method display a options menu 330 including a plurality of different authorization methods. The illustrated menu includes the reply method, where any reply from the telephone number is accepted as a proper response, and the name check method, where the name received must be checked as a legitimate sender name before the reply is accepted as a proper response. Selection of ok returns the user to the settings menu 328. Selection of the enter your name option displays a name input screen 332 where the mobile device user may input their name into the mobile device's memory. A similar input screen may be included to provide any additional information about the mobile device user. Selection of ok returns the user to the settings menu 328. Selection of enable/disable displays an enable/disable screen 340 where the user may choose to enable or disable the SMS authorisation system on the mobile telephone. A country code options display 336 may be included to change the country code of the super white list. A country code display 338 may be used to change the country code. Modification of the settings may be protected by a pin number display 334 where the proper pin number must be entered before settings may be changed.

The sender may provide a response to the verification request in any suitable manner. In one embodiment, the sender provides information about the intended recipient such as the recipients name. In another embodiment, the sender may need to provide one or more of a password, key, token, and other electronic objects that authenticate the sender's identity.

Certain procedures may be needed for the situation where both the sender and the recipient are using the SMS authorising system so that the verification request received by the sender is not seen as an unauthorised message. The verification request must be allowed to pass through to the sender without causing a verification request to be sent in the opposing direction. In one embodiment, verification messages are identified by certain formatting rules that can be distinguished from conventional SMS messages. In another embodiment, the system may expect to receive a verification request for a short period after the SMS message is sent out of the sender's system.

In one embodiment of the invention, the sender lists may be stored in the SIM card or other memory means on the mobile device. Referring generally to FIG. 1, when an SMS message is received by the mobile device 102, a file or database lookup is conducted of the SIM card or other memory means. In another embodiment, the sender lists may be stored in a network database such as, for example, the database 118 coupled to the system server 106. When an SMS message is sent to the user of the SMS authorising system, the SMS message and associated information are sent to the system server 106 over the communications network via the one or more gateways 114. A database lookup may then be performed to determine whether the sender's telephone number is on one of the sender lists. If the SMS message is on a list allowing display to the user, the SMS message may be released from the SMS system server 106 and forwarded to the mobile device 102.

Predetermined billing procedures may be incorporated into the system so that mobile telephone users to do not bear all of the cost of sending and receiving verification SMS messages. In one embodiment, if a verification request is sent to the sender, the user is not charged for the receipt of the SMS message until a verification response is received. In another embodiment, if the SMS message is blocked due to the inclusion of the associated telephone number on the black list, the user may not be charged for receiving the blocked SMS message. In the embodiment where the SMS filter system server 106 receives the message, the user may not be charged until the SMS message is forwarded onto the user. In another embodiment, the mobile telephone carrier may bear the additional message verification costs as an incentive for users to subscribe to the particular carrier.

Those skilled in the art will appreciate that the above-described system may be implemented in a variety of configurations. For example, specific communication protocols have been identified with reference to the illustrated mobile network. Other suitable communications lines and communication protocols may be used. Also, while the application and the various sender lists are described as using the SMS sender's telephone number to make decisions regarding displaying, queuing, and deleting SMS messages, other means may be used to identify the sender of the SMS message. For example, because SMS message may be sent using the Internet and electronic mail (emails), email address and IP addresses may be used to determine the identity of the SMS message sender. Therefore, each of the super white list, the white list, the black list, and the list of pending verification requests may also include email addresses and IP addresses or any other suitable sender identification. While SMS message formats have been described, embodiments of the present invention may also support multimedia message service (MMS), email messages, and any other desired communication formats. Also, the example application user interface shown in FIG. 3 describes certain functions and inputs. However, other functions and inputs may be incorporated into the user interface such as, for example, input, searching, and adding of email addresses and IP addresses into the sender lists. Any number of sender lists may also be included in the user interface.

The previous description of the exemplary embodiments is provided to enable any person skilled in the art to make or use the present invention. While the invention has been described with respect to particular illustrated embodiments, various modifications to these embodiments will readily be apparent to those skilled in the art, and the generic principles defined herein may be applied to other embodiments without departing from the spirit or scope of the invention. It is therefore desired that the present embodiments be considered in all respects as illustrative and not restrictive. Accordingly, the present invention is not intended to be limited to the embodiments described above but is to be accorded the widest scope consistent with the principles and novel features disclosed herein.

1. A method for delivering short message service (SMS) messages sent by a sender to a recipient over a communications network, the method including: receiving an SMS message from the sender; sending an automatic verification request to the sender requesting a verification response, wherein the verification request is sent before the SMS message is delivered to the recipient; receiving the verification response from the sender; and delivering the SMS message to the recipient upon receiving the verification response.

2. A method according to claim 1, further including verifying the SMS message, wherein the SMS message includes a sender identification and verifying the SMS message includes comparing the one or more sender lists, the one or more sender lists including a white list, and the SMS message is delivered to the recipient where the sender identification is included in the white list, and a verification request is sent to the sender where the sender identification is not included in the white list.

3. A method according to claim 1, wherein the sender identification is a mobile telephone number.

4. A method according to claim 1, wherein the sender identification is an email address.

5. A method according to claim 2, wherein the one or more sender lists includes a black list, and the white list includes a list of authorised senders and the black list includes a list of unauthorised senders.

6. A method according to claim 2, wherein the one or more sender lists includes a super white list, and the SMS message is delivered to the recipient where the sender identification is included on a super white list.

7. A method according to claim 1, wherein the SMS message is received by a mobile telephone and wherein delivering the SMS message to the recipient includes allowing display of the SMS message on the mobile telephone.

8. A method according to claim 1, wherein the SMS message is received by a system server and wherein delivering the SMS message to the recipient includes transmitting the SMS message from the system server to the mobile telephone.

9. A method according to claim 6, wherein the super white list is synchronized with a second super white list over the communications network, wherein the second super white list is stored on a system server database.

10. A method according to claim 6, wherein the white list is synchronized with a second white list over the communications network, wherein the second white list is stored on a system server database.

11. A method according to claim 6, wherein the black list is synchronized with a second black list over the communications network, wherein the second black list is stored on a system server database.

12. A method according to any claim 2, wherein the one or more sender lists are stored on a mobile telephone SIM card.

13. A method according to claim 2, wherein the one or more sender lists are stored on a system server database.

14. A method according to claim 5, wherein the SMS message is discarded where the sender identification is included on the a black list.

15. A system for delivering short message service (SMS) messages sent by a sender to a recipient over a communications network, the system including: receiving means for receiving an SMS message from the sender; transmission means for sending an automatic verification request to the sender requesting a verification response, wherein the verification request is sent before the SMS message is delivered to the recipient; receiving means for receiving the verification response from the sender; and delivering means for displaying the SMS message to the recipient upon receiving the verification response.

16. A system according to claim 15 further including verification means for verifying the SMS message, wherein the SMS message includes a sender identification and verifying the SMS message includes comparing the one or more sender lists, the one or more sender lists including a white list, and the SMS message is delivered to the recipient where the sender identification is included in the white list, and a verification request is sent to the sender where the sender identification is not included in the white list.

17. A system according to claim 16, wherein the sender identification is a mobile telephone number.

18. A system according to claim 16, wherein the sender identification is an email address.

19. A system according to claim 16, wherein the one or more sender lists includes a black list, and the white list includes a list of authorised senders and the black list includes a list of unauthorised senders.

20. A system according to claim 16, wherein the one or more sender lists includes a super white list, and the SMS message is delivered to the recipient where the sender identification is included on a super white list.

21. A system according to claim 15, wherein the SMS message is received by a mobile telephone and wherein delivering the SMS message to the recipient includes allowing display of the SMS message on the mobile telephone.

22. A system according to claim 15, wherein the SMS message is received by a system server and wherein delivering the SMS message to the recipient includes transmitting the SMS message from the system server to the mobile telephone.

23. A system according to claim 20, wherein the super white list is synchronized with a second super white list over the communications network, wherein the second super white lists is stored on a system server database.

24. A system according to claim 16, wherein the one or more sender lists are stored on a mobile telephone SIM card.

25. A system according to claim 16, wherein the one or more sender lists are stored in a memory device on a mobile device.

26. A system according to claim 16, wherein the one or more sender lists are stored on a system server database.

27. A system according to claim 19, wherein the SMS message is discarded where the sender identification is included on the a black list.

28. (canceled)

29. (canceled)
